(19) United States
(12) Patent Application Publication
(10) Pub. No.: US 2005/0137275 A1
(43) Pub. Date: Jun. 23, 2005

(54) Polymer dispersions in polyesterpolyols

(75) Inventors: Hartmut Nefzger, Pulheim (DE); Erika Bauer, Juchen (DE); Erhard Michels, Koln (DE); Nils Perchenek, Leverkusen (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/002,942

(22) Filed: Dec. 2, 2004

(30) Foreign Application Priority Data
Dec. 6, 2003 (DE) 10357159.0

(51) Int. Cl. C08L 75/00

(52) U.S. Cl. 521/137

(57) ABSTRACT

The present invention relates to polymer dispersions in polyester polyols, to a process for their preparation, and to the preparation of polyurethanes, especially microcellular polyurethanes, from these polymer dispersions.

### BACKGROUND OF THE INVENTION

The present invention relates to polymer dispersions in polyesterpolyols, to a process for their preparation, and to the preparation of polyurethanes, especially microcellular polyurethanes, from the polymer dispersions.

Dispersions of solid, high-molecular polymers in polyols (i.e. polymer polyols) are frequently used for the production of flexible polyurethane foams. One advantage here is, for example, that the open-cell character of these foams is increased and the mechanical properties are improved as a consequence of the increased hardness. Tear strength, tensile stress and compression set may also be mentioned in this connection. These means make it possible to reduce the density of the foam while retaining the properties otherwise achievable only with a higher density foam. This provides a significant saving of materials, and hence a reduction of the costs.

Dispersions of polymers in polyols are known and described in the literature. In addition to dispersions obtainable by reacting monomers containing olefin groups in polyols, the literature also describes other types of dispersions such as, for example, those prepared from diamines and polyisocyanates. The literature also makes it clear that the base polyols used are generally polyether polyols with molecular weights of 1000 to 10,000 g/mol or, occasionally, polyester polyols. One reason for only occasionally using polyester polyols may lie in the comparatively high viscosity of polyester polyols themselves, and especially in the resulting dispersions based on polyester polyols, particularly in comparison with corresponding systems based on polyether polyols. Nevertheless, dispersions based on polyester polyols are of technical interest, especially because polyurethane systems prepared therefrom have, in many respects, better mechanical properties than the corresponding polyurethanes based on polyether polyols.

For aqueous systems for the production of heat-curable stoving lacquers, DE-OS 44 27 227 describes the use of aqueous dispersions of polyester polyols, filled with polymers of olefinic monomers, as one of the system components.

If styrene is used as a vinylic monomer in such systems, then because of its low reactivity compared with acrylonitrile and the slower chain transfer rate compared to many molecular species, otherwise analogous dispersions are less stable. Accordingly, the use of styrene as a vinylic monomer polymerizable by free-radical polymerization for the preparation of dispersions based on polyester polyols requires the incorporation of grafting sites into or at the end of the polyester polyol molecules. This applies particularly if styrene is used exclusively as the vinylic monomer. Such grafting sites must assure the chain transfer of the polymer molecules growing by a free-radical process, to form covalent bonds and, if possible, to give the growing free-radical chain.

Some examples of such modifications are described in EP-A 250 351. Thus, for example, the incorporation of maleic anhydride into the polyester polyol chain can fulfill this function. EP-A 0 250 351 describes a process in which at least one ethylenically unsaturated monomer is polymerized in a polyester polyol having a molecular weight of 1000 to 5000 g/mol. In this particular case, in addition to the conventional structural units of the polycarboxylic acid and polyalcohol, the polyester polyol also contains olefinic constituents, especially the structural unit maleic anhydride.

However, a disadvantage of the incorporation of such unsaturated polycarboxylic acids or anhydrides that reduce the free mobility of the segments of the polyester chain is the associated increase in viscosity of the polyester polyols or polyester polyol mixtures used. Similarly, the increased concentration of polar ester carbonyl groups due to the incorporation of maleic acid into the polyester chain also has a viscosity-increasing effect. The increased viscosity further restricts the suitability of the polyester polyols, which already are of higher viscosity per se.

In addition to these disadvantages, it has been found, in industrial practice, that in very many cases polyester polyols modified with unsaturated structural units give coarse dispersions that usually contain particles visible to the naked eye and are often difficult to filter.

One particular economic aspect arises from the fact that, for all the processes previously described, a phase-stabilizing additive always has to be prepared first in a separate reaction. Ideally, such an additive would be available on the industrial scale in practically any desired quantity and at a favorable price. Furthermore, it would be characterized in that unused portions would be removable from the reaction product as completely as possible and in the simplest possible manner.

### SUMMARY OF THE PRESENT INVENTION

The object of the present invention was therefore to provide an improved process for the preparation of polymer polyols based on polyester polyols. It has now been found that the addition of double-activated methylene compounds in the process provides an appropriate technical solution.

Thus, the present invention relates to a process for the preparation of polymer dispersions by (1) free-radical polymerizing (a) one or more olefinically unsaturated monomers, in the presence of (b) a base polyester polyol component comprising (1) at least one base polyester polyol without olefinically unsaturated groups, and (c) one or more double-activated methylene compounds which correspond to the general formula:
R¹ —CH₂—R² (I)
in which
   R¹ and R² may be the same or different radicals which represent inductively electron-withdrawing substituents.

Optionally, the above process occurs in the presence of (b) a polyester polyol component without olefinically unsaturated groups that comprises (2) at least one second base polyester polyol without olefinically unsaturated groups.

In accordance with the present invention, the polymer dispersions comprise the free-radical polymerization product of (a) one or more olefinically unsaturated monomers, in the presence of (b) a base polyester polyol component without olefinically unsaturated groups that comprises (1) at least one base polyester polyol without olefinically unsaturated groups, and (c) one or more double-activated methylene compound without olefinically unsaturated groups which corresponds to formula (I) as described above, and optionally, (b) a polyester polyol component without olefinically unsaturated groups that comprises (2) at least one second base polyester polyol without olefinically unsaturated groups.

### DETAILED DESCRIPTION OF THE INVENTION

Suitable compounds to be used as (c) the double-activated methylene compound in accordance with the present invention include those corresponding to the general formula:
R¹ —CH₂—R² (I)
wherein:
   R¹ and R² may be the same or different, and each comprises a radical which represents an inductively electron-withdrawing substituent.

More specifically, suitable inductively electron-withdrawing substituents to be used as R¹ and R² in formula (I) above, include, but are not limited to, —CONH₂, —CN or —COOR³, in which R represents an alkyl radical, preferably a methyl, an ethyl, a propyl, a butyl, a tert-butyl or a cycloisopropylidene group.

In accordance with the present invention, malonic acid esters are particularly preferred to be used as the double-activated methylene compound without olefinically unsaturated groups.

Overall, the proportion of (c) double-activated methylene compound in the total reaction batch, including any solvents and any polyester polyol replenishment, is less than 5 wt. %, preferably less than 3 wt. % and particularly preferably less than 2 wt. %.

The base polyester polyol, component (b) herein, is prepared from components that do not contain olefinic constituents. Base polyester polyols are polycondensation products of diols and dicarboxylic acids or their anhydrides, or low-molecular esters or half-esters, preferably those with monofunctional alcohols such as methanol, ethanol, 1-propanol, 2-propanol, 1-butanol and 2-butanol. These polycondensation products contain hydroxyl end groups.

Examples of suitable diols include compounds such as ethylene glycol, 1,2-propanediol, 1,3-propanediol, 2-methyl-1,3-propanediol, 1,4-butanediol, 1,5-pentanediol, 3-methyl-1,5-pentanediol, 1,6-hexanediol, 1,8-octanediol, 1,10-decanediol, neopentyl glycol, diethylene glycol, triethylene glycol, tetraethylene glycol, etc. Polyether polyols having number-average molecular weights of 250 to 4,500 g/mol are also suitable, and particularly those which predominantly contain units derived from 1,2-propylene oxide. Accordingly, ether oligomers of butanediol, such as dibutylene glycol and tributylene glycol, or corresponding diols obtainable by the ring-opening polymerization of tetrahydrofuran, having number-average molecular weights of 240 to 3,000 g/mol, can also be used as diols. Corresponding compounds of 1,6-hexanediol, dihexylene glycol and trihexylene glycol, or oligomer mixtures obtainable by the azeotropic etherification of 1,6-hexanediol, are also suitable.

It is also possible to incorporate up to 5 wt. % of higher-functional polyols. These higher functional polyols include, for example 1,1,1-trimethylolpropane, glycerol or pentaerythritol, and polypropylene oxide and polyethylene oxide polyols which are based on the latter as starter molecules, and which have number-average molecular weights of 250 to 4,500 g/mol.

Non-olefinic dicarboxylic acids which are suitable include aliphatic and aromatic compounds, either used individually or in a mixture. Examples which may be mentioned include succinic acid, glutaric acid, adipic acid, pimelic acid, suberic acid, sebacic acid, phthalic acid, isophthalic acid and terephthalic acid. It is also possible to use the corresponding anhydrides, and their esters or half-esters with low-molecular, and preferably monofunctional alcohols.

Analogously, esters of cyclic hydroxycarboxylic acids can also be used. Preferred are those which can be prepared from ε-caprolactone.

Accordingly, it is also possible to use or incorporate polyesters of carbonic acid, i.e. polycarbonate polyols. These can be prepared by the transesterification of dimethyl carbonate or diphenyl carbonate with diols and triols, and by the transesterification with oligoesterdiols and oligoetherdiols containing hydroxyl end groups, with number-average molecular weights of 200 to 1000 g/mol.

The polyester polyols suitable for use in accordance with the present invention have a mean hydroxyl functionality of 1.8 to 3, preferably of 1.85 to 2.7 and more preferably of 1.9 to 2.5, and a number-average molecular weight of 1,000 to 5,000, preferably of 1,300 to 4,800 and more preferably of 1,600 to 4,500 g/mol.

If the base polyester polyol component comprises several polyester polyols, the molecular weight limits as set forth in the above paragraph refer to the mixture of polyester polyols. In this case, it is of course possible for the number-average molecular weight of one or more of the individual components to fall outside the above stated, such as, for example, in the range from 450 to 1,600 g/mol.

It is also possible, for example, to modify the base polyester polyol component by mixing the esters used with a low-molecular weight diol or low-molecular weight diol mixtures which have number-average molecular weights of 62 to 400 g/mol and which do not contain any ester groups. This mixing process can also be carried out on the finished dispersion when the free-radical polymerization has ended.

Of course, it is also possible that a mixing process carried out on the finished dispersion after completion of the free-radical polymerization uses a base polyester polyol having a mean hydroxyl functionality of 1.8 to 3, preferably of 1.85 to 2.7 and more preferably of 1.9 to 2.5, and a number-average molecular weight of 1,000 to 5,000, preferably of 1,300 to 4,800 and more preferably of 1,600 to 4,500 g/mol. This is, however, less preferred.

Examples of suitable vinylic monomers (i.e. olefinically unsaturated monomers) for use as component (a) in accordance with the present invention, and which are polymerizable by free-radical polymerization include, but are not limited to, styrene, alpha-methylstyrene, ethylstyrene, vinyltoluene, divinylbenzene, isopropylstyrene, chlorostyrene, butadiene, isoprene, pentadiene, acrylic acid, methacrylic acid, methyl methacrylate, vinyl acetate, acrylonitrile, methyl vinyl ketone or combinations of these compounds. It is preferable to use styrene, alpha-methylstyrene, acrylonitrile, methacrylonitrile and alkyl methacrylates having C₁-C₃₀ alkyl radicals (e.g. methyl, ethyl, butyl, hexyl, dodecyl, etc.). It is particularly preferable to use styrene and acrylonitrile, with the styrene being used in a proportion of preferably more than 75 wt. % and most preferably more than 90 wt. %.

In accordance with the present invention, the proportion in the total batch of these vinylic monomers polymerizable by free-radical polymerization, to be used is such that the filler content (i.e. solids content) of the finished dispersion is from 2 to 55 wt. %, preferably from 4 to 40 wt. % and particularly preferably from 5 to 33 wt. %. The filler content (i.e. solids content) can be adjusted by post-dilution with a second base polyester polyol.

In a preferred embodiment of the invention, the base polyester polyol, component (b), used comprises two different polyester polyols which differ at least with respect to their number-average molecular weights. In this preferred embodiment, the polyester polyol having the smaller molecular weight is mixed in only when the free-radical polymerization of the vinylic monomer in the mixture of polyester polyol having the higher molecular weight has ended.

The free-radical polymerization is initiated using any free-radical initiators which are known per se. Examples of suitable initiators from the group of the azo initiators include alpha, alpha′-azo-2-methylbutyronitrile, alpha, alpha′-azo-2-heptonitrile, 1,1′-azo-1-cyclohexanecarbonitrile, dimethyl alpha, alpha′-azoisobutyrate, 4,4′-azo-4-cyanopentanoic acid, azobis(2-methylbutyronitrile) and azobisisobutyronitrile. The following compounds are mentioned as examples of other suitable initiators from the group of the peroxides, persulfates, perborates and percarbonates: dibenzoyl peroxide, acetyl peroxide, benzoyl hydroperoxide, t-butyl hydroperoxide, di-t-butyl peroxide, 2-ethylhexanoic acid tert-butyl perester, diisopropyl peroxydicarbonate, etc.

The free-radical polymerization is typically carried out in the presence of a solvent, but can also be effected without a solvent. Examples of suitable solvents for the present invention include solvents such as benzene, toluene, xylene, acetonitrile, hexane, heptane, dioxane, ethyl acetate, N,N-dimethylformamide, N,N-dimethylacetamide, etc., and mixtures thereof. Benzene, xylene and toluene are preferred.

The present invention is also directed to the polymer dispersions obtained by the processes as described above. The products (i.e. polymer dispersions) obtained are white dispersions containing a high-molecular weight polymer or copolymer, a conventional polyester polyol that is solid or, preferably, liquid at room temperature, and another modified polyester polyol necessary for phase stabilization. By way of example, the polymer dispersions of the present invention may have a filler content of 25 wt. % of polystyrene, an OH number of from 50 to 60, and they can have viscosities of 15,000 to 35,000 mPas at 25° C., and preferably of 3,000 to 8,000 mPas at 50° C. The viscosity of the polymer dispersion is proportional to the viscosity of the base polyester polyol used, and inversely proportional to the OH number of the base polyester polyol.

The polymer polyols prepared according to the invention are suitable for the preparation of polyurethanes or polyurethane materials, and particularly for the preparation of microcellular polyurethane elastomers such as those used, for example, in the production of shoe soles. The invention also relates to polyurethanes comprising the reaction product of the polymer dispersions according to the invention, with polyisocyanates or polyisocyanate prepolymers and shoe soles comprising the reaction product of the polymer dispersions with polyisocyanates or polyisocyanate prepolymers.

The polymer dispersions according to the invention result in polyurethanes which have a greater hardness than polyurethanes prepared without a polymer dispersion, at the same density. If not only the density but also the hardness of the resultant polyurethane is to be kept constant, the process of the present invention can be carried out with a markedly reduced amount of polyisocyanate by using the polymer dispersions according to the invention.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

A.) Base polyesterpolyols
B.) Preparation of polymer dispersions according to the invention
C.) Comparative Example
   A.) Base polyester polyols: The following base polyester polyols were used in the examples.
   A.1. Base polyester polyol A.1):

A commercially available polyadipate polyester polyol prepared from adipic acid and equimolar proportions of ethylene glycol and diethylene glycol, with an OH number of approx. 56 mg KOH/g and a viscosity of approx. 520 mPas (75° C.).

A.2. Base polyesterpolyol of High Molecular weight A.2.):

This polyester polyol was prepared by slowly heating 2779 g (26.22 mol) of diethylene glycol, 813 g (13.12 mol) of ethylene glycol and 5452 g (37.12 mol) of adipic acid to 200° C., with the elimination of water. When the formation of water had ended, the mixture was cooled to 120° C. and catalyzed with 180 mg of tin dichloride. The reaction mixture was heated slowly to 200° C. over 4 h under a water jet vacuum, with additional water being eliminated. The mixture was left to stand for a further 24 h under these reaction conditions, and the hydroxyl number was then determined as 27.8 mg KOH/g and the acid number as 0.8 mg KOH/g.

A.3. Base Polyester Polyol of Low Molecular Weight A.3.):

Base polyester polyol A.3.) was prepared by slowly heating 3177 g (29.97 mol) of diethylene glycol, 932 g (15.03 mol) of ethylene glycol and 5256 g (36 mol) of adipic acid to 200° C., with the elimination of water. When the formation of water had ended, the mixture was cooled to 120° C. and catalyzed with 180 mg of tin dichloride. The reaction mixture was heated slowly to 200° C. over 4 h under a water jet vacuum, with additional water being eliminated. The mixture was left to stand for a further 24 h under these reaction conditions, and the hydroxyl number was then determined as 120.1 mg KOH/g and the acid number as 0.3 mg KOH/g.

B.) Preparation of Polymer Dispersions According to the Invention

476 g of a polyesterpolyol A.2.) with a hydroxyl number of 27.8 mg KOH/g were stirred with 3 g of diethyl malonate, 100 g of toluene, and 1 g of azobis(2-methylbutyronitrile). A gentle stream of nitrogen was passed through the solution for 20 min, 80 g of styrene were added and the mixture was heated to 80° C. over 30 min., with stirring. After 20 min. at 80° C., the temperature was raised to 120° C. over a further 30 min.

A previously prepared solution of 600 g of polyesterpolyol A.2.), 21 g of diethyl malonate, 200 g of toluene, 6.4 g of azobis(2-methylbutyronitrile) and 800 g of styrene was metered into the above mixture over 2 hr. at an initial speed of rotation of 300 rpm, with the speed being increased to 350 rpm after 20 min and to 400 rpm after a further 40 min. When this metered addition had ended, the reaction was allowed to continue for 5 min.

Another previously prepared solution of 38 g of polyesterpolyol A.2.), 4 g of diethyl malonate, 100 g of toluene and 0.6 g of azobis(2-methylbutyronitrile) was then metered in over 30 min. When the addition had ended, the reaction was allowed to continue for 2 hours at 120° C.

For work-up of the reaction mixture, it was first placed under a water jet vacuum in order to extensively remove the solvent, any unreacted styrene and free diethyl malonate residues. This was completed by applying an oil pump vacuum, with styrene, toluene and diethyl malonate having been very extensively removed after 2 hr. at 0.5 mbar.

The hydroxyl number of the resultant product was determined as 17.2 mg KOH/g. The OH number and the polystyrene filler content were then adjusted by dilution of the product with 1108 g of polyesterpolyol A.3).

The resultant dispersion could be filtered on a 200 μm sieve, was phase-stable and had a viscosity of 26,500 mPas at 25° C. and of 5540 mPas at 50° C.; the filler (i.e. solids) content was approx. 23.3 wt. % and the OH number was 57.7 mg KOH/g.

C.) Comparative Example:

This product was prepared using the procedure as described above in B).

| | |
|---|---|
| Initial ingredients: | 476 g of polyesterpolyol A.1). |
| | 100 g of toluene |
| | 66 g of butanediol |
| | 0.6 g of azobis(2-methylbutyronitrile) |
| | 80 g of styrene |

These were heated to 120° C. and the following mixtures were metered in analogously to Example B.:

| | |
|---|---|
| Addition 1: | 600 g of polyesterpolyol A.1). |
| | 533 g of styrene |
| | 5.4 g of azobis(2-methylbutyronitrile) |
| | 200 g of toluene |
| Addition 2: | 38 g of polyesterpolyol A.1). |
| | 0.6 g of azobis(2-methylbutyronitrile) |
| | 50 g of toluene |

The reaction product could not be filtered.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for the preparation of polymer dispersions comprising
(1) free-radical polymerizing
(a) one or more olefinically -unsaturated monomers, in the presence of
(b) a base polyester polyol component comprising
(1) at least one base polyester polyol without olefinically unsaturated groups, and
(c) a double-activated methylene compound without olefinically unsaturated groups, and, optionally,
(b) a polyester polyol component comprising
(2) at least one second polyester polyol without olefinically unsaturated groups.

2. The process of claim 1, wherein (c) the double-activated methylene compound corresponds to the general formula:
R¹—CH₂—R²
wherein:
R¹ and R² may be the same or different, and each is individually selected from radicals which comprise inductively electron-withdrawing substituents.

3. The process of claim 2, wherein each R¹ and R² are independently of one another selected from the group consisting of the radicals —CONH₂, —CN or —COOR³, wherein R³=alkyl.

4. The process of claim 1, wherein (a) said olefinically unsaturated monomers are selected from the group consisting of styrene, alpha-methylstyrene, ethylstyrene, vinyltoluene, divinylbenzene, isopropylstyrene, chlorostyrene, butadiene, isoprene, pentadiene, acrylic acid, methacrylic acid, methyl methacrylate, vinyl acetate, acrylonitrile, methyl vinyl ketone and mixtures thereof.

5. The process of claim 1, wherein (b) said polyester polyol component comprises (1) one or more polycarbonate polyols without olefinically unsaturated groups.

6. The polymer dispersion produced by the process of claim 1.

7. In a process for the preparation of polyurethanes, comprising reacting a polyisocyanate component with an isocyanate-reactive component, the improvement wherein at least a portion of the isocyanate-reactive component comprises the polymer dispersion of claim 6.

8. A shoe sole comprising the reaction product of a polyisocyanate component with the polymer dispersion of claim 6.
